(19) United States
(12) Patent Application Publication
(10) Pub. No.: US 2005/0251360 A1
(43) Pub. Date: Nov. 10, 2005

(54) Connection apparatus and method for process monitoring

(75) Inventors: Rajiv K. Bhateja, Oak Ridge, TN (US); Chander P. Bhateja, Oak Ridge, TN (US); Anjali K. Bhateja, Oak Ridge, TN (US)

Correspondence Address: LUEDEKA, NEELY & GRAHAM, P.C., P O BOX 1871, KNOXVILLE, TN, 37901, US

(73) Assignee: ANR, L.P.

(21) Appl. No.: 11/184,584

(22) Filed: Jul. 19, 2005

Related U.S. Application Data
(63) Continuation-in-part of application No. 10/764,615, filed on Jan. 26, 2004.

(51) Int. Cl. G01D 18/00

(52) U.S. Cl. 702/127; 702/104; 340/531; 340/870.3

(57) ABSTRACT

A connection unit, also referred to herein as Quick Connect Box (QCB), is installed on each industrial machine to be monitored in a production plant. Each connection unit is “coded” to correspond to the particular production machine to which it is installed. The code may be binary or a certain sequence of digital alphanumeric characters, a certain pattern of analog voltages at certain locations in the QCB unit's electronic circuits, or other means. The code or the signal pattern may identify the significant attributes of the machine being monitored, such as the machine name and type, plant name, asset number, the department and physical location within the plant, the operation number, and the types of sensors mounted on the machine and their set ranges.

### FIELD

This application claims priority as a continuation-in-part to U.S. patent application Ser. No. 10/764,615 filed Jan. 26, 2004.

### BACKGROUND

This invention pertains to an apparatus used in monitoring and controlling a production process. More specifically, this invention pertains to an apparatus connected to a production machine that acquires and analyzes data about the production process and adjusts the production machine to improve the efficiency of the production process.

U.S. patent application Ser. No. 10/764,615 describes a Flexible Process Optimizer (FPO) for optimizing the operation of a machine used in a production process. As described in that application, the FPO may be used in large production environments wherein many machines are used to carry out various manufacturing processes. Each of these machines may have several sensors installed thereon for real-time measurement of desired process characteristics during the production process.

When the FPO is used in such an environment, efficiency of the monitoring process is improved if the FPO can automatically identify the machine to which it is connected and automatically load monitoring configuration information for that machine and the sensors attached thereto. It is conceivable that such configuration information could involve a large number of items related to the details of the process parameters monitored. Such information may include process parameter names, sensor types and full range calibration data for every sensor input. Having to manually enter such configuration information for each machine being monitored and calibrate each sensor input would make the process monitoring effort laborious, time consuming, and prone to errors.

What is needed, therefore, is an apparatus and method for automatically loading configuration information into a machine monitoring device, such as the FPO, as the monitoring device is used on various machines in a manufacturing environment.

### SUMMARY

To address this and other needs, the invention provides a connection unit, also referred to herein as Quick Connect Box (QCB), for installation on each monitored machine in a production plant. Each QCB unit is “coded” to correspond to the particular production machine to which it is installed. The code may be a digital code or a certain pattern of analog voltages at certain locations in the QCB unit's electronic circuits. This digital code or signal pattern may be used to identify significant attributes of the machine being monitored, such as the machine name and type, plant name, asset number, the department and physical location within the plant, the operation number, and the types of sensors mounted on the machine and their set ranges.

In one embodiment, the invention includes a multi-conductor cable that brings the individual sensor inputs from the QCB to the machine monitoring device, such as the FPO. In addition to the sensor signals, the multi-conductor cable also carries the “code” for the machine and sensor identification information that enables the FPO to load the appropriate configuration for process monitoring for the specific machine.

Thus, one of the objectives of the invention is to provide the user of the FPO a ready means of monitoring a production machine in a busy production environment without having to perform an elaborate manual setup, to facilitate process troubleshooting and to maintain high production efficiency.

In one preferred embodiment, the invention comprises a connection apparatus for providing an electrical connection between an industrial process monitoring unit, such as the FPO, and sensors mounted on an industrial machine. The connection apparatus includes a connection unit housing, a plurality of sensor inputs, an identification circuit for storing information related to the sensors mounted on the machine, and a multi-conductor connector that provides an electrical connection between the connection apparatus and the industrial process monitoring unit. The sensor inputs receive sensor signal wires from the sensors mounted on the industrial machine, where the sensor signal wires carry sensor signals generated by the sensors. The multi-conductor connector includes contacts that are in electrical communication with corresponding sensor inputs, as well as contacts that are in electrical communication with the machine identification circuit.

In a most preferred embodiment, the connection apparatus includes a multi-conductor cable having connectors at each end. At one end, the cable connector mates with the multi-conductor connector on the connection unit housing. At the other end, the cable connector mates with the industrial process monitoring unit. The cable includes a plurality of signal wires for carrying the sensor signals and the information related to the sensors from the connection apparatus to the industrial process monitoring unit.

In one preferred embodiment, the identification circuit comprises a network of components that provide the sensor information as one or more specific voltage levels. In another embodiment, the identification circuit comprises a memory device for storing the sensor information as a digital code.

In another aspect, the invention provides a method for monitoring a machine used in an industrial process. The method includes generating one or more sensor signals related to one or more operational parameters of the machine and receiving the sensor signals at a connection unit that is disposed with the machine. The method further includes electrically connecting an industrial process monitoring unit to the connection unit and transferring the sensor signals from the connection unit to the industrial process monitoring unit. Identification information that identifies the sensors or the machine or both is accessed from an identification circuit. In a preferred embodiment, the identification circuit is in the connection unit. In an alternative embodiment, the identification circuit is in the monitored machine. Based on the identification information, the operation of the industrial process monitoring unit is adjusted as needed.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a Flexible Process Optimizer connected to a manufacturing machine by way of a quick connect interface box according to a preferred embodiment of the invention;

FIG. 2 depicts a Quick Connect Box according to a preferred embodiment of the invention; and

FIG. 3 depicts a flow diagram of a machine monitoring process according to a preferred embodiment of the invention.

### DETAILED DESCRIPTION

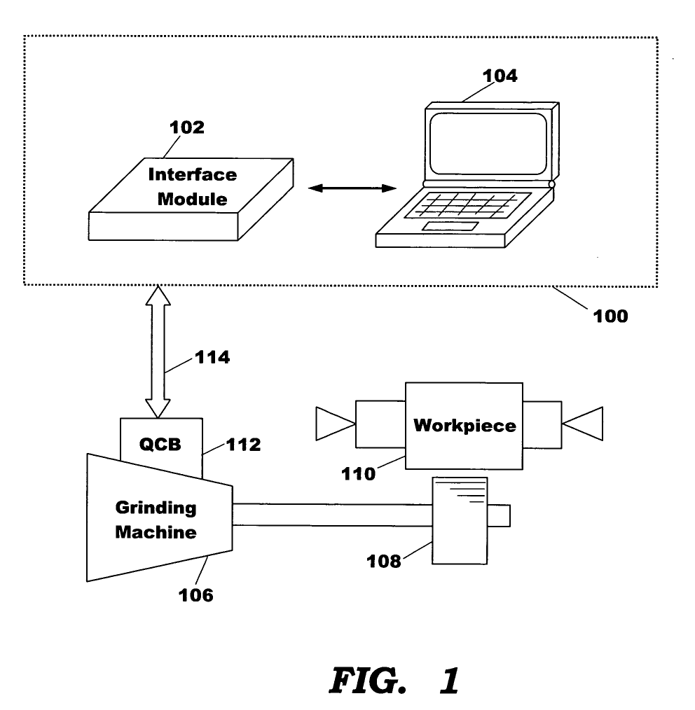

FIG. 1 depicts a Flexible Process Optimizer (FPO) 100 for monitoring a production machine 106 performing a production process. In this particular example, the machine 106 is a grinding machine having a grinding wheel 108 that engages a workpiece 110. The flexible process optimizer 100 and its method of use is the subject matter of U.S. patent application Ser. No. 10/764,615, the entire contents of which are incorporated herein by reference. As described in that application, the FPO 100 includes an interface module 102 and a processing device 104 and is used in monitoring various types of machines and processes using various types of sensors.

Generally, each sensor is physically placed on the monitored machine in a suitable location for measuring the desired process parameter. The measured parameters may include electrical power (watts), fluid flow (gallons/minute), pressure (psi or bars), and temperature (degrees F. or C.). Preferably, each sensor is calibrated individually for the best range and measurement resolution for its particular measurement parameter. As the FPO 100 is used to monitor processes on various machines having various types of sensors, the FPO 100 will need to be initialized for different operational parameters.

In a preferred embodiment of the invention, setup information regarding the operational parameters to be used in the setup of the FPO 100 is provided by an interface circuit 112, which is also referred to herein as a Quick Connect Box (QCB). Preferably, there is a dedicated QCB 112 assigned to each monitored machine in the manufacturing environment. As the FPO 100 is moved from one machine to another in the manufacturing environment, the FPO 100 receives its setup information from the QCB 112 that is attached to the monitored machine. In a most preferred embodiment, QCB 112 includes a housing 130 with attachment brackets for semi-permanent attachment of the QCB 112 to the monitored machine 106.

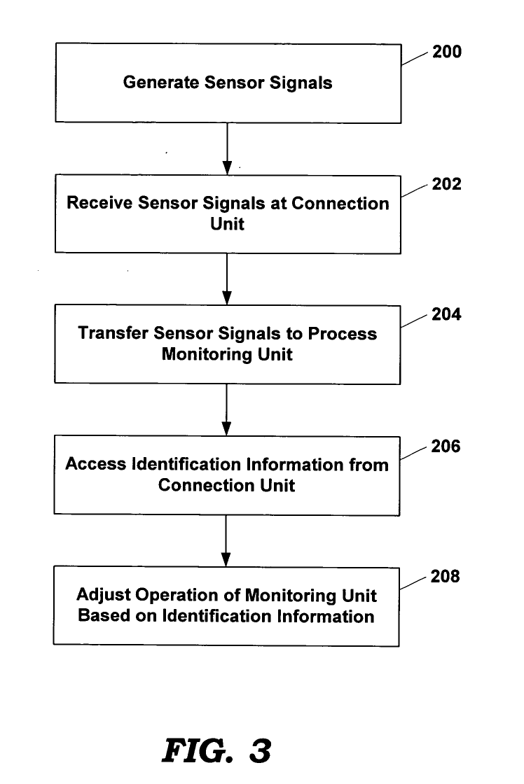

As shown in the preferred embodiment depicted in FIGS. 1, 2 and 3, sensors 116a-116c are attached the monitored machine 106 for monitoring the process performed by the machine 106. As the machine performs its process, the sensors 116a-116c generate sensor signals (step 200 in FIG. 3). The sensor signals are received at the QCB 112 via sensor wires connected to a connector strip 124 within the housing 130 of the QCB 112 (step 202). The connector strip 124 is electrically connected to a quick-disconnect multi-conductor connector 122a attached to the housing of the QCB 112. The connector 122a receives a mating connector 122b that is attached to a multi-conductor cable 114. At the other end of the cable 114 is a quick-disconnect connector 126a that is removably attached to a mating connector 126b on the FPO 100.

Through the cable 114, the FPO 100 receives the sensor signals from the sensors 116a-116c attached to the monitored machine 106 (step 204). In addition to the sensor signals, the multi-conductor cable 114 carries identification information to identify the machine 106 and sensor information that enables the FPO 100 to load specific configuration parameters for process monitoring for that specific machine (step 206). Preferably, the needed configuration parameters are loaded from memory located in the FPO 100 or from a library of “configuration files.”

In the preferred embodiment, upon reading the machine identification information from the QCB 112 through the multi-conductor cable 114, the FPO 100 uses pre-programmed logic in the FPO 100 or a “look-up table” for the needed set up information. The FPO 100 then automatically loads the identification and monitoring configuration file and automatically adjusts its operation accordingly (step 208). The configuration file may contain many pieces of information, the entry of which into the FPO 100 would be fairly time consuming if done manually by the user.

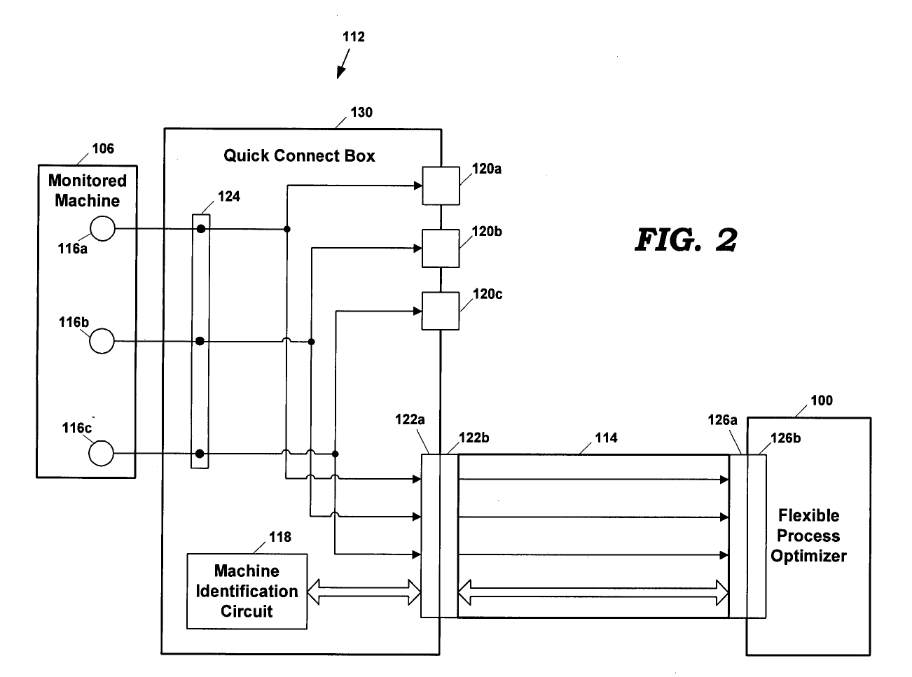

As shown in FIG. 2, the machine/sensor information is stored in the QCB 112 in a machine identification circuit 118. In one preferred embodiment, the machine identification circuit 118 comprises a network of active or passive components that provide a specific combination of voltages. The combination of voltages is recognized by the FPO 100 as corresponding to a particular machine in a particular location in a manufacturing plant and having a particular combination of sensors 116a-116c thereon. A power supply for yielding the particular voltage combination may be provided in the QCB 112 or in the FPO 100. Such an identification method may be referred to as a pseudo-analog technique.

In an alternative preferred embodiment, the identifying information in the QCB 112 comprises a digital code assigned to each monitored machine. The code preferably resides in nonvolatile memory in the machine identification circuit 118 and is accessed by the FPO 100 via a serial or parallel interface provided through the multi-conductor cable 114. The multi-conductor cable 114 in this context may consist of just one single cable or a combination of several cables each carrying a certain group of signals or information. This provides full flexibility in bringing in all needed sensor signals as well as the identification information into the FPO 100.

In another embodiment, the FPO 100 reads coded signals from the machine identification circuit 118 to determine what sensors 116a-116c are present on the machine 106. The FPO 100 then executes software that provides the user with an interactive menu-driven series of questions to determine the user's immediate measurement objectives. Based on the sensor information and the user's responses to the questions, the FPO 100 develops an optimum configuration for monitoring the machine.

In one preferred embodiment of the invention, the QCB 112 also includes individual input connectors 120a-120c that provide connection to the sensors 116a-116c on the machine 106. Using the connectors 120a-120c and individual sensor input cables, an alternative method of sensor input to the FPO 100 is provided. If the FPO 100 senses that multiple sensors 116a-116c are connected to the FPO 100 via the connectors 120a-120c using individual cables, software running on the FPO 100 asks the user to select the monitored machine from a list previously created by the user. Based on the user's responses, the FPO 100 loads appropriate configuration information from its library. Preferably, the loaded configuration information identifies which sensors 116a-116c are deployed on the particular machine 106 and their preferred specific full-scale ranges, which may be then calibrated automatically by the FPO 100.

Using software running on the FPO 100, the user may modify any item of the monitoring setup information and save preferred process monitoring configurations under user-defined file names for future use. The FPO 100 may store multiple machine monitoring configurations from which the user may select depending on the monitoring objective. Such objectives may include diagnosing a machine or quality problem, optimizing a process for efficiency, or performing a routine periodic audit to ensure correct system operation.

The foregoing description of preferred embodiments of this invention has been presented for purposes of illustration and description. The described embodiments are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A connection apparatus for providing electrical connection between an industrial process monitoring unit and sensors mounted on an industrial machine, the connection apparatus comprising:
a connection unit housing;
a plurality of sensor inputs disposed in the connection unit housing for receiving sensor signal wires from the sensors mounted on the industrial machine, the sensor signal wires carrying sensor signals generated by the sensors;
an identification circuit for storing information related to the machine or the sensors mounted on the machine;
a first multi-conductor connector disposed on the connection unit housing for providing electrical connection between the connection apparatus and the industrial process monitoring unit, the first multi-conductor connector comprising:
one or more contacts in electrical communication with one or more corresponding sensor inputs; and
one or more contacts in electrical communication with the identification circuit for transferring the information related to the sensors mounted on the machine.

2. The connection apparatus of claim 1 further comprising a multi-conductor cable comprising:
a second multi-conductor connector for mating with the first multi-conductor connector on the connection unit housing;
a third multi-conductor connector for mating with the industrial process monitoring unit; and
a plurality of signal wires that electrically connect the second multi-conductor connector to the third multi-conductor connector, the plurality of signal wires for carrying the sensor signals and the information related to the sensors from the connection apparatus to the industrial process monitoring unit.

3. The connection apparatus of claim 1 wherein the sensor inputs comprise a connector strip providing for semi-permanent attachment of the sensor signal wires.

4. The connection apparatus of claim 1 further comprising individual quick-disconnect connectors in the housing, each electrically connected to a corresponding sensor input, thereby providing additional means of accessing the individual sensor signals.

5. The connection apparatus of claim 1 wherein the identification circuit comprises a network of components that provide the sensor information as one or more specific voltage levels on one or more contacts of the first multi-conductor connector.

6. The connection apparatus of claim 5 wherein the sensor information further comprises a specific combination of voltage levels corresponding to a particular combination of sensors on the monitored machine.

7. The connection apparatus of claim 5 wherein the sensor information further comprises a specific combination of voltage levels for identifying a particular machine within an industrial facility.

8. The connection apparatus of claim 1 wherein the identification circuit comprises a memory device for storing the sensor information as a digital code indicating a particular combination of sensors on the monitored machine.

9. The connection apparatus of claim 1 wherein the identification circuit comprises a memory device for storing the sensor information as a digital code identifying a particular machine within an industrial facility.

10. The connection apparatus of claim 1 wherein the identification circuit is disposed in the connection unit housing.

11. The connection apparatus of claim 1 wherein the identification circuit is disposed in the monitored machine.

12. A method for monitoring a machine used in an industrial process, the method comprising:
(a) generating one or more sensor signals related to one or more operational parameters of the machine;
(b) receiving the sensor signals at a connection unit disposed with the machine;
(c) electrically connecting an industrial process monitoring unit to the connection unit;
(d) transferring the sensor signals from the connection unit to the industrial process monitoring unit;
(e) accessing identification information from an identification circuit in the connection unit; and
(f) adjusting operation of the industrial process monitoring unit based on the identification information.

13. The method of claim 12 wherein step (c) further comprises electrically connecting the industrial process monitoring unit to the connection unit via a multi-conductor cable, step (d) further comprises transferring the sensor signals from the connection unit to the industrial process monitoring unit via the multi-conductor cable, and step (e) further comprises accessing the identification information from the identification circuit via the multi-conductor cable.

14. The method of claim 12 wherein step (e) further comprises accessing sensor identification information from the identification circuit, and step (f) further comprises adjusting operation of the industrial process monitoring unit based on the sensor identification information.

15. The method of claim 12 wherein step (e) further comprises accessing machine identification information from the identification circuit, and step (f) further comprises adjusting operation of the industrial process monitoring unit based on the machine identification information.

16. The method of claim 12 wherein step (e) further comprises determining one or more specific voltage levels provided by a network of electrical components in the identification circuit, and step (f) further comprises adjusting operation of the industrial process monitoring unit based on the one or more specific voltage levels.

17. The method of claim 12 wherein step (e) further comprises reading a digital code from a memory device in the identification circuit, and step (f) further comprises adjusting operation of the industrial process monitoring unit based on the digital code.
